(19) United States
(12) Patent Application Publication
(10) Pub. No.: US 2011/0074284 A1
(43) Pub. Date: Mar. 31, 2011

(54) COMPOSITION FOR PROTECTIVE LAYER OF PLASMA DISPLAY PANEL, PLASMA DISPLAY PANEL AND METHOD OF MANUFACTURING THE SAME

(76) Inventors: Jong-Hee Lee, Suwon-si (KR); Kyu-Nam Joo, Suwon-si (KR); Jae-Myung Kim, Suwon-si (KR); Dong-Hyun Kang, Suwon-si (KR); Young-Su Kim, Suwon-si (KR)

(21) Appl. No.: 12/711,116

(22) Filed: Feb. 23, 2010

Related U.S. Application Data
(60) Provisional application No. 61/246,850, filed on Sep. 29, 2009.

(51) Int. Cl. H01J 17/49; C09D 1/00

(52) U.S. Cl. 313/587; 106/286.1; 106/286.6; 106/286.7; 106/286.4; 106/286.3; 106/287.2; 106/287.26; 106/287.28; 106/287.3; 106/287.24

(57) ABSTRACT

A composition for a protective layer of a plasma display panel includes a metal oxide powder containing a metal selected from Mg, Cu, Ca, Sr, Ba, Zn, Mn, Fe, Al, Ti, Zr, Sn, Ce and combinations thereof, a dispersing agent, and a solvent selected from nitrile compounds, tertiary alkyl acetates, alkylene glycol alkyl ethers, dichloromethane, tetrahydrofuran and combinations thereof. Also, a plasma display panel includes a protective layer formed of the composition for a protective layer, and a manufacturing method thereof.

### CROSS REFERENCE TO RELATED APPLICATION

This application claims priority to and the benefit of U.S. Provisional Patent Application Ser. No. 61/246,850, filed on Sep. 29, 2009 in the U.S. Patent and Trademark Office, the entire content of which is incorporated herein by reference.

### BACKGROUND OF THE INVENTION

(a) Field of the Invention

This disclosure relates to compositions for protective layers of plasma display panels (PDP), PDPs including the protective layers, and methods of manufacturing the same.

(b) Description of the Related Art

A plasma display panel is a display device that forms images by exciting phosphor layers with vacuum ultraviolet (VUV) rays generated by gas discharge in discharge cells. As the PDP can have a wide screen with high resolution, it has been spotlighted as a next generation flat panel display.

The three-electrode surface-discharge type PDP has been widely used. In the three-electrode surface-discharge PDP, display electrodes (each including two electrodes) are positioned on a front substrate, and address electrodes are positioned on a rear substrate that is separated from the front substrate by a predetermined space. The display electrodes are covered with a dielectric layer. The space between the front substrate and the rear substrate is partitioned into a plurality of discharge cells by barrier ribs, and a discharge gas is placed inside the discharge cells. A phosphor layer is formed toward the rear substrate.

Also, a protective layer is formed over the dielectric layer to reduce the effect of ion impact during discharge. The protective layer may be formed of a composition containing metal oxide powder mixed with a solvent, and it is important that the metal oxide powder be uniformly distributed in the composition.

### SUMMARY OF THE INVENTION

According to embodiments of the present invention, a composition for forming a protective layer of a plasma display panel (PDP) can improve the uniformity of the protective layer.

In another embodiment of the present invention, a plasma display panel includes a protective layer formed of the composition.

In yet another embodiment of the present invention, a method for manufacturing the plasma display panel is provided.

According to an exemplary embodiment of the present invention, the composition for a protective layer of a plasma display panel includes a metal oxide powder containing a metal selected from Mg, Cu, Ca, Sr, Ba, Zn, Mn, Fe, Al, Ti, Zr, Sn, Ce and combinations thereof, a dispersing agent, and a solvent selected from nitrile compounds, tertiary alkyl acetates, alkylene glycol alkyl ethers, dichloromethane, tetrahydrofuran and combinations thereof.

The solvent may have a viscosity of lower than about 2.0 cps at room temperature. The nitrile compound may include acetonitrile. The tertiary alkyl acetate may include t-butyl acetate, and the alkylene glycol alkyl ether may include propylene glycol methyl ether.

The metal oxide powder may have an average particle diameter of about 450 nm to about 1 μm.

The amount of the metal oxide powder may range from about 0.1 wt % to about 30 wt % based on the amount of the solvent.

The dispersing agent may be selected from DISPER BYK-103 (manufactured by BYK chemical company), DISPER BYK-110 (manufactured by BYK chemical company), DISPER BYK-182 (manufactured by BYK chemical company), BYKOPLAST-1000 (manufactured by BYK chemical company) and combinations thereof. The amount of the dispersing agent may range from about 1 wt % to about 7 wt % based on the amount of the metal oxide powder.

According to another exemplary embodiment of the present invention, a method for manufacturing a plasma display panel includes: forming a first display panel including a plurality of address electrodes, forming a second display panel including a plurality of display electrodes, and assembling the first display panel with the second display panel. Forming the second display panel includes forming the display electrodes on a substrate, forming a dielectric layer covering the display electrodes, and forming a protective layer by coating the composition for a protective layer on the dielectric layer. Forming the protective layer may include spraying the composition for a protective layer on the dielectric layer.

According to yet another exemplary embodiment of the present invention, a plasma display panel includes a first substrate and a second substrate arranged facing each other. A plurality of address electrodes are positioned on one side of the first substrate, a first dielectric layer covers the address electrodes, and barrier ribs are positioned between the first substrate and the second substrate for partitioning a plurality of discharge cells. A phosphor layer is positioned in the discharge cells. A plurality of display electrodes are positioned on one side of the second substrate in a direction generally perpendicular to a direction of the address electrodes, a second dielectric layer covers the display electrodes, and a protective layer covers the second dielectric layer. The protective layer is formed using the composition for a protective layer.

The protective layer may have a thickness of about 0.5 μm to about 10 μm.

### BRIEF DESCRIPTION OF THE DRAWINGS

FIG. 1 is an exploded perspective view of a plasma display panel according to one embodiment of the present invention.

FIG. 2 is a photograph comparing the dispersion levels of the compositions prepared according to Examples 1 to 3 and those prepared according to Comparative Examples 1 and 2 after the compositions were allowed to stand at room temperature for five days.

### DETAILED DESCRIPTION OF THE EMBODIMENTS

According to embodiments of the present invention, a composition for a protective layer of a plasma display panel (PDP) includes a metal oxide powder containing a metal selected from Mg, Cu, Ca, Sr, Ba, Zn, Mn, Fe, Al, Ti, Zr, Sn, Ce and combinations thereof, a dispersing agent, and an organic solvent. The metal oxide powder (which is a main element of the protective layer of the plasma display panel) may reduce the discharge voltage and protect the dielectric layer from being damaged by sputtering. The metal oxide powder may have a relatively large average particle diameter of about 450 nm to about 1 μm.

The dispersing agent may uniformly disperse the metal oxide powder in the solvent. In particular, the dispersing agent should be able to sufficiently disperse the metal oxide powder having the large particle diameter. The dispersing agent may be selected from DISPER BYK-103 (manufactured by BYK chemical company), DISPER BYK-110 (manufactured by BYK chemical company), DISPER BYK-182 (manufactured by BYK chemical company), BYKOPLAST-1000 (manufactured by BYK chemical company) and combinations thereof. The dispersing agent substantially prevents the metal oxide powder having a large particle diameter from agglomerating so that the composition maintains a stable dispersion state.

The organic solvent mixes the metal oxide powder with the dispersing agent, and may be selected from nitrile compounds, tertiary alkyl acetates, alkylene glycol alkyl ethers, dichloromethane, tetrahydrofuran and combinations thereof. The organic solvent may have a viscosity of lower than about 2.0 cps at room temperature. The organic solvent having such a low viscosity can secure fluidity of the metal oxide powder in the solvent, which leads to increased dispersion.

Also, since the organic solvent is readily volatilized at room temperature, it substantially prevents the metal oxide powder from agglomerating and decreasing dispersion, thereby increasing preservative capability at room temperature.

Also, since the organic solvent has a relatively high dielectric constant ranging from about 7 F/m to about 36 F/m, little electrostatic interaction occurs during volatilization, which also helps prevent the metal oxide powder from agglomerating. Thus, it is possible not only to form a protective layer of a sufficient thickness but also to secure dispersion characteristics of the solution. Therefore, a uniform protective layer can be formed.

In addition, since the organic solvent has an appropriate level of surface tension ranging from about 20 dyne/cm³ to 28 dyne/cm³, it has good adhesion to the lower layer (such as the substrate or dielectric layer) and can help prevent the protective layer from coming off of the lower layer after drying.

The organic solvent may be included in an amount calculated by excluding the above mentioned constituent elements from the total amount of the composition. That is, the solvent makes up the remainder of the composition after excluding the other elements.

The metal oxide may be included in an amount of about 0.1 wt % to about 30 wt % based on the amount of the organic solvent. Within this range, a high-concentration dense metal oxide layer having good dispersion is formed.

The dispersing agent may be included in an amount of about 1 wt % to 7 wt % based on the amount of the metal oxide powder. When the dispersing agent is included within this range, the metal oxide powder may be effectively dispersed while simultaneously securing dispersion stability.

The following examples are presented for illustrative purposes only, and do not limit the scope of the present invention.

### Preparation of Composition for Protective Layer

### Example 1

0.8 g of DISPER BYK-182 as a dispersing agent was added to 100 Ml of acetonitrile and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Example 2

0.8 g of DISPER BYK-182 as a dispersing agent was added to 100 Ml of dichloromethane and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Example 3

0.8 g of DISPER BYK-182 as a dispersing agent was added to 100 Ml of t-butyl acetate and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Example 4

0.8 g of DISPER BYK-182 as a dispersing agent was added to 100 Ml of propylene glycol methyl ether and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Example 5

0.8 g of DISPER BYK-182 as a dispersing agent was added to 100 Ml of tetrahydrofuran and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Example 6

0.8 g of DISPER BYK-182 as a dispersing agent was added to 100 Ml of t-butyl acetate and dissolved at room temperature by agitating the solution. 20 g of magnesium oxide powder having an average particle diameter of 700 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Example 7

0.8 g of DISPER BYK-182 as a dispersing agent was added to 100 Ml of t-butyl acetate and dissolved at room temperature by agitating the solution. 20 g of magnesium oxide powder having an average particle diameter of 1 μm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Comparative Example 1

9 g of glycerin as a dispersing agent was added to 100 Ml of ethanol and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Comparative Example 2

10 g of ethylene glycol as a dispersing agent was added to 100 Ml of ethanol and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Comparative Example 3

0.8 g of DISPER BYK-182 as a dispersing agent was added to 100 Ml of tetrachloromethane (viscosity 0.97 cps, dielectric constant 2.24 F/m, sruface tension 35.2 dyne/cm) and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Comparative Example 4

0.8 g of DISPER BYK-182 as a dispersing agent was added to 100 Ml of chloroform (viscosity 0.58 cps, dielectric constant 4.81 F/m, surface tension 28.9 dyne/cm) and dissolved at room temperature by agitating the solution. 20 g of magnesium oxide powder having an average particle diameter of 450 nm was added to the solution to thereby prepare a magnesium oxide dispersion solution. The dispersion solution was placed in an ultrasonic homogenizer to disperse the agglomerated magnesium oxide powder in the solvent for 15 minutes by applying vibration to the solution. The dispersion solution obtained after the ultrasonic homogenization was agitated for 20 minutes with an agitator to thereby prepare a composition.

### Assessment

The compositions for a protective layer prepared according to Examples 1 to 7 and Comparative Examples 1 to 4 were allowed to stand at room temperature and variations in the dispersion rate according to the number of days that the compositions were allowed to stand (i.e., 1 day, 3 days, 5 days, 7 days and 10 days) were measured. The dispersion rates were measured at room temperature based on the following Equation.

dispersion rate (%)={(height of a turbid layer of a composition in a container)−(height of a precipitation layer of the composition+height of a transparent layer))*100/(height of the turbid layer of the composition in the container)}

When the amount of precipitation is great, the dispersion rate is low. The lower the precipitation amount, the higher the dispersion rate becomes.

The results were as shown in Table 1.

TABLE 1

| | Days after | | | Days after | |
|---|---|---|---|---|---|
| | being allowed | | | being allowed | |
| | to stand | Dispersion | | to stand | Dispersion |
| | (days) | rate (%) | | (days) | rate (%) |
| Ex. 1 | 1 | 100 | Ex. 7 | 1 | 100 |
| | 3 | 100 | | 3 | 100 |
| | 5 | 96 | | 5 | 96 |
| | 7 | 92 | | 7 | 92 |
| | 10 | 85 | | 10 | 87 |
| Ex. 2 | 1 | 100 | Comp. | 1 | 0 |
| | 3 | 100 | Ex. 1 | 3 | 0 |
| | 5 | 100 | | 5 | 0 |
| | 7 | 95 | | 7 | 0 |
| | 10 | 91 | | 10 | 0 |
| Ex. 3 | 1 | 100 | Comp. | 1 | 0 |
| | 3 | 100 | Ex. 2 | 3 | 0 |
| | 5 | 100 | | 5 | 0 |
| | 7 | 100 | | 7 | 0 |
| | 10 | 97 | | 10 | 0 |
| Ex. 4 | 1 | 100 | Comp. | 1 | 97 |
| | 3 | 94 | Ex. 3 | 3 | 91 |
| | 5 | 90 | | 5 | 82 |
| | 7 | 84 | | 7 | 77 |
| | 10 | 81 | | 10 | 70 |
| Ex. 5 | 1 | 100 | Comp. | 1 | 92 |
| | 3 | 89 | Ex. 4 | 3 | 82 |
| | 5 | 85 | | 5 | 78 |
| | 7 | 81 | | 7 | 72 |
| | 10 | 74 | | 10 | 61 |
| Ex. 6 | 1 | 100 | | | |
| | 3 | 100 | | | |
| | 5 | 97 | | | |
| | 7 | 96 | | | |
| | 10 | 94 | | | |

As shown in Table 1, the compositions for a protective layer prepared according to Examples 1 to 7 showed little variation in their dispersion rate over time (i.e., 1 day, 3 days, 5 days, 7 days and 10 days). In particular, the composition prepared according to Example 1 maintained its initial dispersion rate until 3 days after it was allowed to stand, and when 10 days passed, the composition maintained a good dispersion rate of about 85%. The composition prepared according to Example 2 maintained its initial dispersion rate until 5 days after it was allowed to stand, and even after 10 days passed, the composition maintained a good dispersion rate of about 91%. The composition prepared according to Example 3 maintained its initial dispersion rate until 7 days after it was allowed to stand, and even after 10 days passed, the composition maintained a good dispersion rate of about 97%. The composition prepared according to Example 4 maintained a good dispersion rate of about 90% after 5 days, and the composition prepared according to Example 5 maintained a good dispersion rate of about 85% after 5 days. The composition prepared according to Example 6 maintained a good dispersion rate of about 94% after 10 days, and the composition prepared according to Example 7 maintained a good dispersion rate of about 87% after 10 days. Therefore, in the inventive compositions, even when the metal oxide powder has a relatively large average particle size of about 450 nm to about 1 μm, the metal oxide powder remains effectively dispersed even after being allowed to stand for several days.

On the contrary, the compositions of Comparative Examples 1 and 2 (which used different solvents and dispersing agents from those of the Examples) showed bad dispersion rates because the magnesium oxide powder precipitated within one day after the compositions were allowed to stand at room temperature. Also, the compositions of Comparative Examples 3 and 4 (using the same metal oxide powder, particle size and dispersing agent as Examples 1 to 4, but different solvents) showed significantly lower dispersion rates after 10 days (70% and 61%, respectively) than the compositions of Examples 1 to 7.

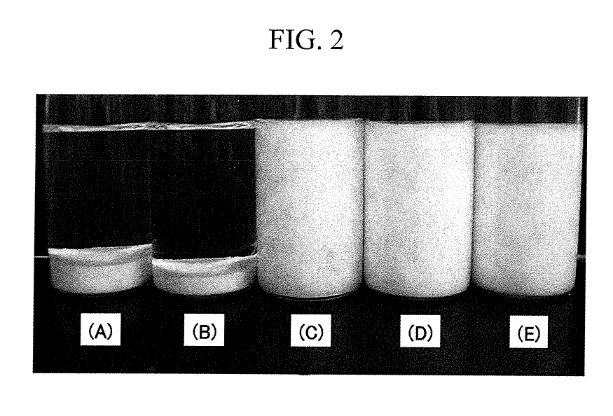

FIG. 2 shows these results. FIG. 2 is a photograph comparing the extent of dispersion of the compositions prepared according to Examples 1 to 3 and Comparative Examples 1 and 2 after they were allowed to stand at room temperature for five days. As shown in FIG. 2, very little magnesium oxide powder precipitated from the compositions of Examples 1 to 3 (referred to as ‘C,’ ‘D’ and ‘E,’ respectively), but most of the magnesium oxide powder precipitated from the compositions of Comparative Examples 1 and 2 (referred to as ‘A’ and ‘B,’ respectively).

Accordingly, when the inventive compositions are used, magnesium oxide powder precipitation is substantially prevented even after several days, and the dispersion properties of the compositions are maintained intact. This indicates that the inventive compositions have good preservative properties at room temperature.

Although the Examples show results only for magnesium oxide powder, the same result may be produced for metal oxide powders other than magnesium oxide powders, including metal oxide powders including metals selected from Cu, Ca, Sr, Ba, Zn, Mn, Fe, Al, Ti, Zr, Sn, Ce and combinations thereof.

Hereafter, a plasma display panel using the above-described composition for a protective layer according to embodiments of the present invention will be described. In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

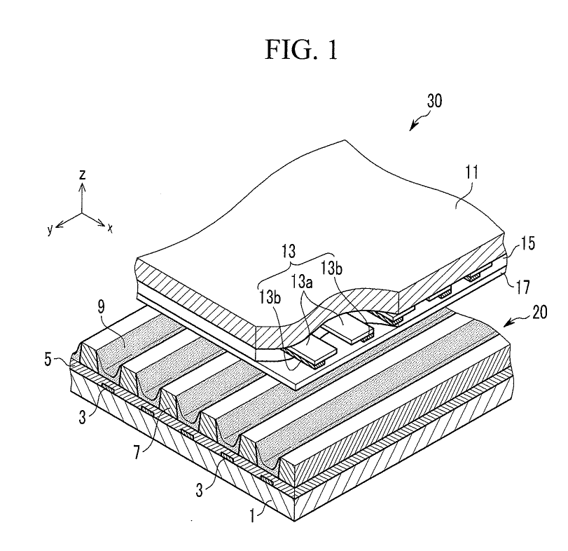

FIG. 1 is an exploded perspective view of a plasma display panel according to one embodiment of the present invention. Referring to FIG. 1, the plasma display panel includes a first display panel 20 and a second display panel 30 which are disposed substantially in parallel to each other and separated from each other by a distance.

The first display panel 20 will now be described. A plurality of address electrodes 3 are formed on the first substrate 1 in one direction (i.e., the Y-axis direction in FIG. 1), and a first dielectric layer 5 is formed on the address electrodes 3. The first dielectric layer may cover the entire surface of the substrate. The first dielectric layer 5 accumulates wall charges and prevents positive ions or electrons from colliding directly with the address electrodes 3 during discharge, thereby protecting the address electrodes 3 from being damaged.

A plurality of barrier ribs 7 are formed on the first dielectric layer 5 between the address electrodes 3. The barrier ribs 7 are formed with a height and have a shape (such as stripes) for partitioning discharge spaces. However, the shape and size of the barrier ribs 7 are not limited so long as the ribs can partition the discharge spaces. The barrier ribs 7 may have any suitable shape, for example, closed shapes such as waffle shapes, matrix shapes, and delta shapes, and open shapes, such as stripes.

A plurality of discharge cells are formed between the barrier ribs 7, and a phosphor layer 9 is formed inside the discharge cells. The phosphor layer absorbs vacuum ultraviolet (VUV) rays and discharges visible light to display fundamental colors (i.e., red, green and blue). The spaces inside the discharge cells are filled with a discharge gas to generate the vacuum ultraviolet (VUV) ray through gas discharge. The discharge gas may be selected from helium (He), neon (Ne), argon (Ar), xenon (Xe) and mixtures thereof.

The second display panel 30 (which faces the first display panel 20) will now be described. On the side of the second substrate 11 facing the first substrate 1, a plurality of display electrodes 13 are formed in a direction intersecting the direction of the address electrodes 3 (i.e., the X-axis direction in FIG. 1). Each display electrode 13 includes a pair of electrodes including a transparent electrode 13a and a bus electrode 13b which overlap each other.

The transparent electrode 13a causes a surface discharge inside a discharge cell, and may be formed of a transparent conductor such as ITO or IZO to secure the aperture ratio of the discharge cell. The bus electrode 13b supplies a voltage signal to the transparent electrode 13a and may be formed of a metal having a low resistance to thereby prevent the resistance from decreasing.

On one side of the display electrodes 13, a second dielectric layer 15 is formed. The second dielectric layer may cover the entire substrate. The second dielectric layer 15 protects the display electrodes 13 from gas discharge while accumulating wall charges during discharge.

The second dielectric layer 15 includes a protective layer 17 formed on one side. The protective layer 17 may be formed of the composition described above.

Discharge cells are formed at the intersection of the address electrodes 3 and the display electrodes 13. The plasma display panel operates by applying an address voltage (Va) between the address electrodes 3 and the display electrodes 13, thereby performing address discharge, and also by applying a sustain voltage (Vs) between a pair of display electrodes 13, thereby performing sustain discharge. An excitation source generated from the sustain discharge excites a corresponding phosphor layer to thereby emit visible light through the second substrate 11 and thus display an image. The phosphors are usually excited by vacuum ultraviolet (VUV) rays.

Herein, the discharge gas filling the discharge cells may be selected from helium (He), neon (Ne), argon (Ar), xenon (Xe) and mixtures thereof.

According to embodiments of the present invention, a protective layer may be formed of a composition with a homogeneously dispersed metal oxide. The protective layer may have a uniform and sufficient thickness ranging from about 0.5 μm to about 10 μm. Since the metal oxide powder is not agglomerated, no stain is caused, thereby improving the display characteristics.

Hereafter, a method for manufacturing a plasma display panel (PDP) will be described. A plasma display panel is manufactured by fabricating a first display panel 20 and a second display panel 30 through separate processes, hermetically combining the two display panels 20 and 30 with each other, exhausting internal gas, and inserting a discharge gas.

The first display panel 20 may be fabricated through conventional processes of fabrication, hermetic sealing, exhaustion, and gas implantation.

The second display panel 30 may be fabricated by first forming a plurality of display electrodes 13 on the substrate 11, and forming the second dielectric layer 15 on the display electrodes 13. Subsequently, the composition for a protective layer is sprayed on the second dielectric layer 15. The solvent is dried at a temperature ranging from about 80° C. to about 120° C. to thereby form a protective layer 17.

While the present invention has been described in connection with certain exemplary embodiments, it is understood by those of ordinary skill in the art that certain modifications may be made to the described embodiments without departing from the spirit and scope of the present invention, as defined by the appended claims.

What is claimed is:

1. A composition for a protective layer of a plasma display panel, the composition comprising:
a metal oxide powder having an average particle diameter of about 450 nm or greater;
a dispersant; and
a solvent having a viscosity of lower than about 2 cps at room temperature, a dielectric constant of about 7 F/m to about 36 F/m, and a surface tension of about 20 dyne/cm³ to about 28 dyne/cm³.

2. The composition of claim 1, wherein the metal oxide powder comprises a metal selected from the group consisting of Mg, Cu, Ca, Sr, Ba, Zn, Mn, Fe, Al, Ti, Zr, Sn, Ce, and combinations thereof.

3. The composition of claim 1, wherein the metal oxide powder has an average particle diameter of about 450 nm to about 1 μm.

4. The composition of claim 1, wherein the metal oxide powder is present in an amount of about 0.1 wt % to about 30 wt % based on the amount of solvent.

5. The composition of claim 1, wherein the solvent is selected from the group consisting of nitrile compounds, tertiary alkyl acetates, alkylene glycol alkyl ethers, dichloromethane, tetrahydrofuran, and combinations thereof.

6. The composition of claim 1, wherein the solvent is selected from the group consisting of acetonitrile, t-butyl acetate, propylene glycol methyl ether, dichloromethane, tetrahydrofuran, and combinations thereof.

7. The composition of claim 1, wherein the dispersant is present in an amount of about 1 wt % to about 7 wt % based on the amount of metal oxide powder.

8. A plasma display panel, comprising:
a first substrate comprising a plurality of address electrodes and a first dielectric layer on the address electrodes;
a second substrate facing the first substrate and comprising a plurality of display electrodes, a second dielectric layer on the display electrodes, and a protective layer on the second dielectric layer, the protective layer being formed from a composition comprising:
a metal oxide powder having an average particle diameter of about 450 nm or greater;
a dispersant; and
a solvent having a viscosity of lower than about 2 cps at room temperature, a dielectric constant of about 7 F/m to about 36 F/m, and a surface tension of about 20 dyne/cm³ to about 28 dyne/cm³.

9. The plasma display panel of claim 8, wherein the metal oxide powder comprises a metal selected from the group consisting of Mg, Cu, Ca, Sr, Ba, Zn, Mn, Fe, Al, Ti, Zr, Sn, Ce, and combinations thereof.

10. The plasma display panel of claim 8, wherein the metal oxide powder has an average particle diameter of about 450 nm to about 1 μm.

11. The plasma display panel of claim 8, wherein the metal oxide powder is present in the protective layer in an amount of about 0.1 wt % to about 30 wt % based on the amount of solvent.

12. The plasma display panel of claim 8, wherein the solvent is selected from the group consisting of nitrile compounds, tertiary alkyl acetates, alkylene glycol alkyl ethers, dichloromethane, tetrahydrofuran, and combinations thereof.

13. The plasma display panel of claim 8, wherein the solvent is selected from the group consisting of acetonitrile, t-butyl acetate, propylene glycol methyl ether, dichloromethane, tetrahydrofuran, and combinations thereof.

14. The plasma display panel of claim 8, wherein the dispersant is present in the protective layer in an amount of about 1 wt % to about 7 wt % based on the amount of metal oxide powder.
